(19) United States
(12) Patent Application Publication
(10) Pub. No.: US 2012/0070691 A1
(43) Pub. Date: Mar. 22, 2012

(54) RADIO FREQUENCY TRANSPARENT VAPOR BARRIER

(75) Inventor: Thomas W. Graf, Blue Ridge, TX (US)

(73) Assignee: Raytheon Company

(21) Appl. No.: 12/885,916

(22) Filed: Sep. 20, 2010

(51) Int. Cl. B32B 15/01; B05D 5/12

(52) U.S. Cl. 428/701; 427/126.4

(57) ABSTRACT

In some examples, the technology described herein includes a radio frequency transparent vapor barrier assembly. The barrier assembly includes a substrate having a three-dimensional surface. The barrier assembly further includes at least one barrier stack positioned adjacent to the three-dimensional surface of the substrate. The at least one barrier stack includes at least one first inorganic layer and at least one second inorganic layer. The least one barrier stack substantially prevents vapor penetration to the substrate.

### GOVERNMENT SUPPORT

The invention was supported, in whole or in part, by a grant (2001-521) from U.S. Department of Defense. The Government has certain rights in the invention.

### BACKGROUND

Radomes for high speed broadband radar systems are generally made of hermitic ceramic or composite materials. However, composite materials do not generally offer the hermitic environment supplied by their ceramic counterparts. Therefore enclosed electronic assemblies in composite materials need to be protected from vapor ingress (e.g., water vapor ingress). Generally, a vapor barrier is applied to the radome to increase the useful life of the electronic assemblies and to decrease the time between failures of the electronic assemblies. However, existing materials for vapor barriers degrade under high temperatures, thereby causing radome and/or electronics failures in high temperature environments. Thus, there is a need in the art for an improved radio frequency transparent vapor barrier.

### SUMMARY

An aspect of a radio frequency transparent vapor barrier is a radio frequency transparent vapor barrier assembly. The radio frequency transparent vapor barrier assembly includes a substrate having a three-dimensional surface. The radio frequency transparent vapor barrier assembly further includes at least one barrier stack positioned adjacent to the three-dimensional surface of the substrate. The at least one barrier stack includes at least one first inorganic layer and at least one second inorganic layer. The least one barrier stack substantially prevents vapor penetration to the substrate.

Another aspect of a radio frequency transparent vapor barrier is a process. The process for making a radio frequency transparent vapor barrier assembly includes providing a substrate having a three-dimensional surface. The process further includes assembling at least one barrier stack atop the three-dimensional surface of the substrate by forming a first inorganic layer and forming a second inorganic layer. The least one barrier stack substantially prevents vapor penetration to the substrate.

Any of the aspects described herein can include one or more of the following examples.

In some examples, the three-dimensional surface of the substrate has at least one three-dimensional surface characteristic. The three-dimensional surface characteristic includes non-uniform and/or substantially course.

In other examples, both the at least one first inorganic layer and the at least one second inorganic layer include silica oxide, lanthanium, alumina oxide, magnesium oxide, hafnium, indium oxide, sodium, sodium oxide, magnesium, magnesium oxide, manganese, manganese oxide, strontium, strontium oxide, titanium, titanium oxide, yttrium, yttrium oxide, zinc, zinc oxide, and/or zirconium oxide.

In some examples, the at least one second inorganic layer includes silica oxide and/or lanthanium.

In other examples, the at least one first inorganic layer includes alumina oxide, magnesium oxide, hafnium, indium oxide, sodium, sodium oxide, magnesium, magnesium oxide, manganese, manganese oxide, strontium, strontium oxide, titanium, titanium oxide, yttrium, yttrium oxide, zinc, zinc oxide, and/or zirconium oxide.

In some examples, the at least one barrier stack is substantially radio frequency transparent.

In other examples, the at least one barrier stack allows for radio frequency propagation of 1 Megahertz through 110 gigahertz.

In some examples, the at least one barrier stack is substantially infrared light transparent.

In other examples, the at least one barrier stack is substantially thermally stable.

In some examples, the substrate includes a composite material, a glass material, a polymer material, and/or a material with limited porosity.

In other examples, the at least one barrier stack includes alternating layers of a plurality of the first inorganic layers and a plurality of the second inorganic layers.

The vapor barrier techniques described herein can provide one or more of the following advantages. An advantage of the vapor barrier is the inorganic layers do not degrade and/or lose vapor barrier properties under high temperatures, thereby increasing the effective temperature range for the vapor barrier and increasing the useful life of the vapor barrier and the substrate. Another advantage of the vapor barrier is the inorganic properties of the inorganic layers allow the vapor barrier to adhere to and seal the three-dimensional surface, thereby decreasing vapor penetration to the substrate and prolonging the useful life of the substrate.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 is a diagram of an exemplary radio frequency transparent vapor barrier assembly;

FIG. 2 is a cross-sectional view of another exemplary radio frequency transparent vapor barrier assembly;

FIG. 3 is a diagram of another exemplary radio frequency transparent vapor barrier assembly;

FIG. 4 is a chart illustrating exemplary water vapor transmission through a plurality of materials; and

FIG. 5 is a flowchart depicting an exemplary process for making a radio frequency transparent vapor barrier assembly.

### DETAILED DESCRIPTION

Radio frequency (RF) transparent vapor barrier technology, as described herein, can be utilized as a vapor barrier coating/encapsulation (also referred to as barrier stack) of electronic packages to prevent vapor ingress (e.g., water vapor ingress, nitrogen gas ingress, oxygen gas ingress, carbon dioxide gas ingress, etc.). The technology includes a multi-layer barrier coating that is inorganic, thereby advantageously effectively protecting the electronic packages at high temperatures. The inorganic properties of the inorganic layers allow the vapor barrier to adhere to and seal three-dimensional surface, thereby advantageously protecting the electronic packages from vapor penetration. The technology is RF transparent, thermally stable, provides low vapor transmission, and/or is customizable to specific program applications.

As a further description of exemplary aspects of the technology, the vapor barrier includes alternating layers of inorganic layers (e.g., a silica layer and an alumina oxide layer) to substantially prevent vapor transfer (i.e., provide low water vapor transfer).

As a further description of exemplary aspects of the technology, the vapor barrier coating is made on top of a substrate by depositing alternating inorganic layers (e.g., silica layer, alumina oxides layer, etc.) by vacuum coating and/or ion bombardment. The multi-layers of the vapor barrier coating can form, for example, a torturous path for the transmission of a vapor ion through the vapor barrier coating (in other words, the greater number of layers the lower the transmission of vapor ions through the vapor barrier coating). The vapor barrier coating can, for example, include inorganic materials that advantageously maximize the operational performance.

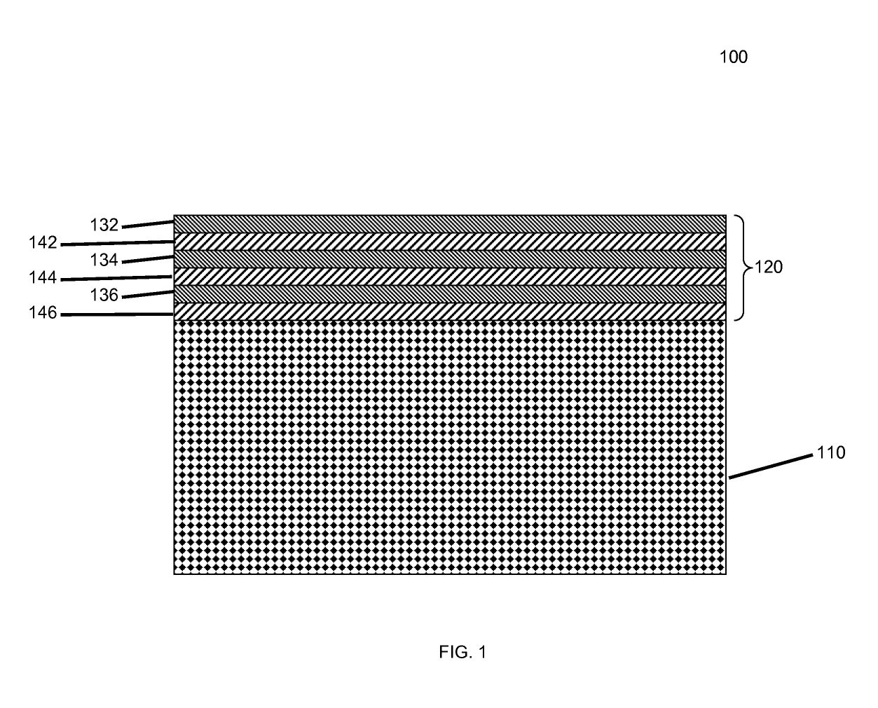

FIG. 1 is a diagram of an exemplary radio frequency transparent vapor barrier assembly 100. The barrier assembly 100 includes a substrate 110 having a three-dimensional surface and a barrier stack 120. The barrier stack 120 is positioned adjacent to the three-dimensional surface of the substrate 110. The barrier stack 120 includes first inorganic layers 132, 134, and 136 and second inorganic layers 142, 144, and 146. The barrier stack 120 substantially prevents vapor penetration to the substrate 110.

In some examples, the three-dimensional surface of the substrate 110 has at least one three-dimensional surface characteristic. The three-dimensional surface characteristic can include, for example, non-uniform (e.g., ridges, holes, bumpy, wavy, peaks and valleys, etc.) and/or substantially course (e.g., rough, uneven, broken, etc.). The barrier stack 120 is applied to the three-dimensional surface of the substrate 110 and advantageously mirrors the three-dimensional surface (i.e., tracks the characteristics of the surface) and remains sealed over the three-dimensional surface, thereby reducing the vapor ion transfer pathways through the barrier stack 120. In contrast, organic layers do not effectively adhere to and seal three-dimensional surfaces.

In other examples, a smoothing layer (not shown) is applied to smooth out part or all of the three-dimensional surface characteristics. In other examples, both the first inorganic layer and the second inorganic layer includes silica oxide, lanthanium, alumina oxide, magnesium oxide, hafnium, indium oxide, sodium, sodium oxide, magnesium, magnesium oxide, manganese, manganese oxide, strontium, strontium oxide, titanium, titanium oxide, yttrium, yttrium oxide, zinc, zinc oxide, and/or zirconium oxide.

In some examples, the second inorganic layer includes silica oxide, and/or lanthanium. In other examples, the first inorganic layer includes alumina oxide, magnesium oxide, hafnium, indium oxide, sodium, sodium oxide, magnesium, magnesium oxide, manganese, manganese oxide, strontium, strontium oxide, titanium, titanium oxide, yttrium, yttrium oxide, zinc, zinc oxide, and/or zirconium oxide.

In some examples, the first inorganic layer and the second inorganic layer include part or all of the same materials. In other examples, the first inorganic layer and the second inorganic layer include different materials. The first inorganic layer and/or the second inorganic layer can include, for example, any type of inorganic material.

In some examples, the barrier stack 120 is substantially radio frequency transparent (e.g., the first inorganic layer and the second inorganic layer include substantially radio frequency transparent materials). In other examples, the barrier stack 120 allows for radio frequency propagation of 1 Megahertz through 110 gigahertz. In this example, the barrier stack 120 does not distort, slow-down, or impede the propagation of radio signals through the barrier assembly 100. For example, the barrier stack 120 allows 97.4% of radio signals through without distortion or interference. As another example, the barrier stack 120 allows 90.9% of radio signals through without distortion or interference.

In some examples, the barrier stack 120 is substantially infrared light transparent (e.g., the first inorganic layer and the second inorganic layer include substantially infrared light transparent materials). For example, the barrier stack 120 allows 99.9% of infrared light through without distortion or interference. As another example, the barrier stack 120 allows 90.9% of infrared light through without distortion or interference.

In other examples, the barrier stack 120 is substantially thermally stable. For example, in environments above 40° Celsius, the barrier stack 120 does not degrade and/or substantially lose effectiveness in preventing vapor penetration through the barrier stack 120. As another example, in environments above 65° Celsius, the barrier stack 120 retains 98% of its ability to prevent vapor penetration through the barrier stack 120. Table 1 illustrates exemplary environments in which the barrier stack 120 retains its ability to prevent vapor penetration.

TABLE 1
Exemplary Environments

| | | | | | Dew | | | |
|---|---|---|---|---|---|---|---|---|
| | | | Temp | RH | Point | Station | Vapor | |
| | Champer | Chamber | at | at | at | Pressure | Pressure of | Density of |
| | Temp | RH | Balance | Balance | Balance | (in. | Water in | Air |
| Date | (C.) | (%) | (C.) | (%) | (C.) | Hg) | Lab (Torr) | (g/L) |
| 13-Sep-2004 | 43.5 | 75.6 | 22.0 | 55.0 | 12.5 | 29.74 | 10.8628 | 1.1828 |
| 14-Sep-2004 | 43.9 | 75.4 | 22.0 | 59.0 | 13.6 | 29.80 | 11.6547 | 1.1847 |
| 15-Sep-2004 | 44.1 | 75.0 | 22.0 | 71.0 | 16.5 | 29.86 | 14.0362 | 1.1857 |
| 16-Sep-2004 | 43.8 | 75.5 | 21.0 | 54.0 | 11.3 | 29.94 | 10.0322 | 1.1954 |
| 17-Sep-2004 | 43.3 | 74.4 | 21.0 | 57.0 | 12.1 | 30.05 | 10.5901 | 1.1994 |
| 20-Sep-2004 | 43.1 | 75.8 | 23.0 | 43.0 | 9.7 | 30.01 | 9.0230 | 1.1907 |
| 21-Sep-2004 | 43.0 | 73.8 | 22.0 | 56.0 | 12.8 | 30.12 | 11.0607 | 1.1979 |
| 22-Sep-2004 | 43.0 | 76.1 | 22.0 | 58.0 | 13.3 | 30.12 | 11.4566 | 1.1977 |
| 23-Sep-2004 | 42.9 | 75.9 | 23.0 | 53.0 | 12.9 | 30.11 | 11.1226 | 1.1934 |

In some examples, the substrate 110 includes a composite material, a glass material, a polymer material, and/or a material with limited porosity. In other examples, the barrier stack 120 includes alternating layers of the first inorganic layers 132, 134, and 136 and the second inorganic layers 142, 144, and 146.

In some examples, the first inorganic layers 132, 134, and 136 include an amphorous material and/or a crystalline material. In other examples, the second inorganic layers 142, 144, and 146 include an amphorous material and/or a crystalline material.

Although FIG. 1 illustrates the barrier stack 120 with three first inorganic layers and three second inorganic layers, the barrier stack 120 can include any number of first inorganic layers and second organic layers (e.g., two first inorganic layers and three second inorganic layers, fifteen first inorganic layers and seventeen second inorganic layers, etc.). Although FIG. 1 illustrates the second inorganic layer 146 positioned adjacent to the three-dimensional surface of the substrate 110, either of the inorganic layers can be positioned adjacent to the three-dimensional surface of the surface of the substrate 110. Although FIG. 1 illustrates the first inorganic layer 132 positioned as the topmost layer positioned away from the three-dimensional surface of the surface of the substrate 110 (in this example, the layer exposed to the environment), either of the inorganic layers can be positioned as the topmost layer positioned away from the three-dimensional surface of the surface of the substrate 110.

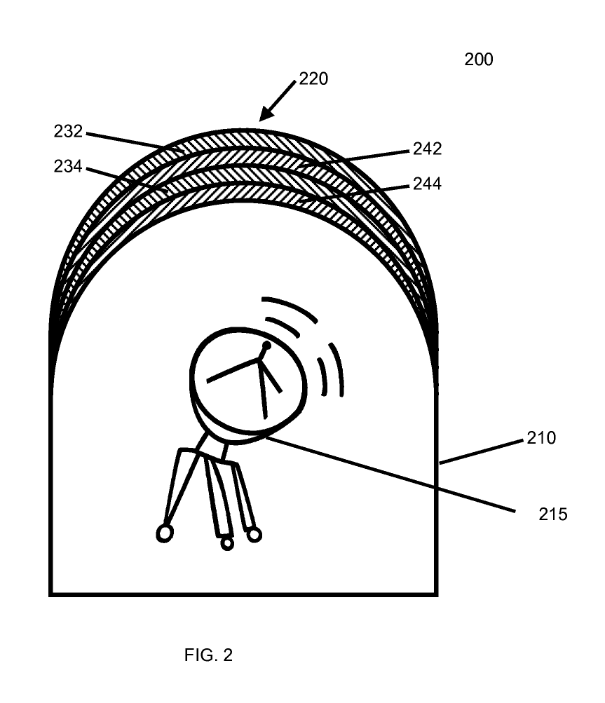

FIG. 2 is a cross-sectional view of another exemplary radio frequency transparent vapor barrier assembly 200. The barrier assembly 200 includes a substrate 210, in this example, a radome covering a radar device 215, and a barrier stack 220. The barrier stack 220 is positioned adjacent to the three-dimensional surface of the substrate 210. The barrier stack 220 includes first inorganic layers 232 and 234 and second inorganic layers 242 and 144. The barrier stack 220 substantially prevents vapor penetration to the substrate 210.

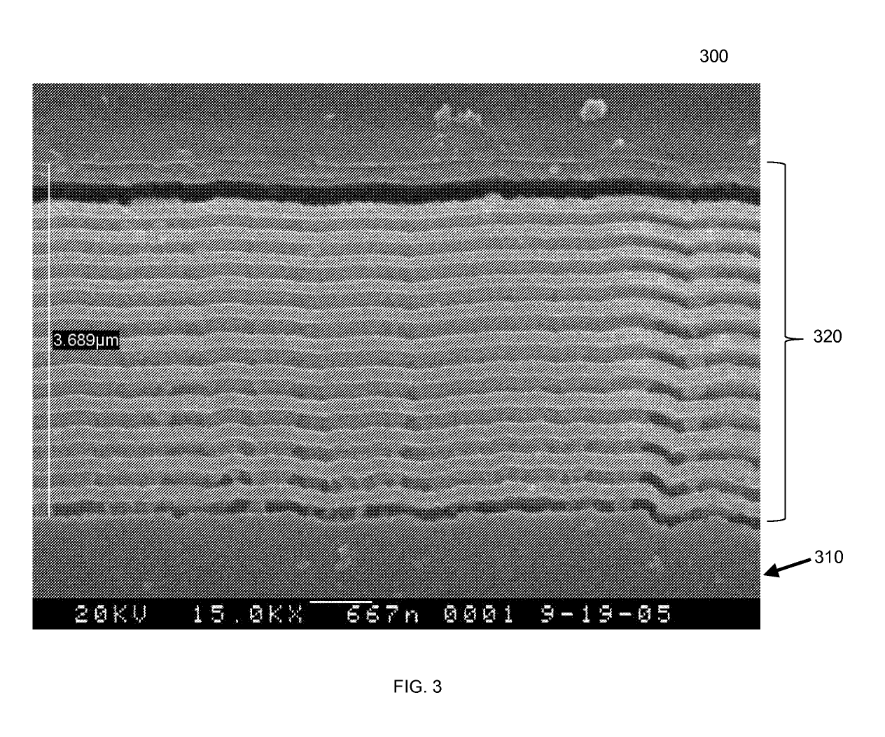

FIG. 3 is a diagram of another exemplary radio frequency transparent vapor barrier assembly 300. The barrier assembly 300 includes a substrate 310 and a barrier stack 320. As illustrated in FIG. 3, the barrier stack 320 includes twenty-four alternating inorganic layers and is 3.689 μm thick. Although FIG. 3 illustrates the barrier stack 320 as 3.689 μm thick, the barrier stack can vary between five hundred and a few thousand angstroms.

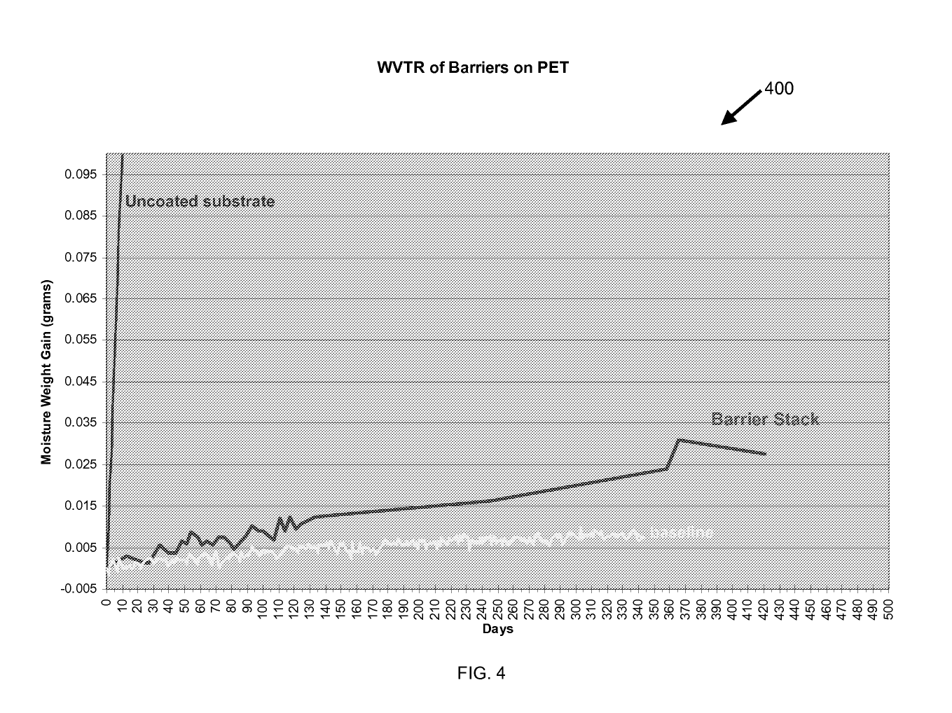

FIG. 4 is a chart 400 illustrating exemplary water vapor transmission through a plurality of materials over approximately five hundred days. The plurality of materials included an uncoated substrate, the technology described herein (referred to as barrier stack), and a baseline of a ceramic radome. As illustrated in the chart 400, the barrier stack had a moisture gain of approximately 0.030 grams over approximately four hundred and twenty days.

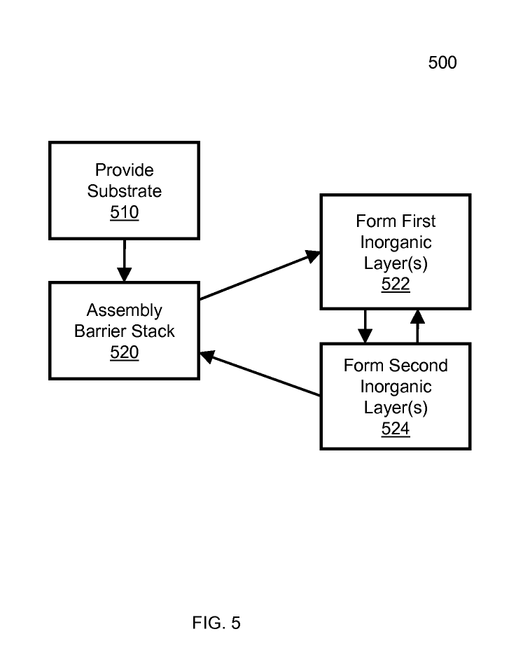

FIG. 5 is a flowchart 500 depicting an exemplary process for making a radio frequency transparent vapor barrier assembly utilizing, for example, a vacuum coating process, an ion bombardment process, and/or any other known application process. The process includes providing (510) a substrate having a three-dimensional surface. The further includes assembling (520) at least one barrier stack atop the three-dimensional surface of the substrate. The assembling includes forming (522) a first inorganic layer and forming (524) a second inorganic layer. The at least one barrier stack substantially prevents vapor penetration to the substrate.

In some examples, the assembling includes forming (522) a plurality of first inorganic layers and forming (524) a plurality of second inorganic layers. The forming of the first and second inorganic layers can be, for example, alternating (in this example, first inorganic layer, second inorganic layer, first inorganic layer, second inorganic layer, etc.).

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. A radio frequency transparent vapor barrier assembly comprising:
a substrate having a three-dimensional surface; and
at least one barrier stack positioned adjacent to the three-dimensional surface of the substrate and comprising at least one first inorganic layer and at least one second inorganic layer;
wherein the least one barrier stack substantially prevents vapor penetration to the substrate.

2. The radio frequency transparent vapor barrier assembly of claim 1, wherein the three-dimensional surface of the substrate having at least one three-dimensional surface characteristic, wherein the three-dimensional surface characteristic comprising non-uniform, substantially course, or any combination thereof.

3. The radio frequency transparent vapor barrier assembly of claim 1, wherein both the at least one first inorganic layer and the at least one second inorganic layer comprises silica oxide, lanthanium, alumina oxide, magnesium oxide, hafnium, indium oxide, sodium, sodium oxide, magnesium, magnesium oxide, manganese, manganese oxide, strontium, strontium oxide, titanium, titanium oxide, yttrium, yttrium oxide, zinc, zinc oxide, zirconium oxide or any combination thereof.

4. The radio frequency transparent vapor barrier assembly of claim 1, wherein the at least one second inorganic layer comprises silica oxide, lanthanium or any combination thereof.

5. The radio frequency transparent vapor barrier assembly of claim 1, wherein the at least one first inorganic layer comprises alumina oxide, magnesium oxide, hathium, indium oxide, sodium, sodium oxide, magnesium, magnesium oxide, manganese, manganese oxide, strontium, strontium oxide, titanium, titanium oxide, yttrium, yttrium oxide, zinc, zinc oxide, zirconium oxide or any combination thereof.

6. The radio frequency transparent vapor barrier assembly of claim 1, wherein the at least one barrier stack is substantially radio frequency transparent.

7. The radio frequency transparent vapor barrier assembly of claim 1, wherein the at least one barrier stack allows for radio frequency propagation of 1 Megahertz through 110 gigahertz.

8. The radio frequency transparent vapor barrier assembly of claim 1, wherein the at least one barrier stack is substantially infrared light transparent.

9. The radio frequency transparent vapor barrier assembly of claim 1, wherein the at least one barrier stack is substantially thermally stable.

10. The radio frequency transparent vapor barrier assembly of claim 1, wherein the substrate comprises a composite material, a glass material, a polymer material, a material with limited porosity, or any combination thereof.

11. The radio frequency transparent vapor barrier assembly of claim 1, further comprising the at least one barrier stack comprising alternating layers of a plurality of the first inorganic layers and a plurality of the second inorganic layers.

12. A process for making a radio frequency transparent vapor barrier assembly comprising:
providing a substrate having a three-dimensional surface; and
assembling at least one barrier stack atop the three-dimensional surface of the substrate by:
forming a first inorganic layer, and
forming a second inorganic layer;
wherein the least one barrier stack substantially prevents vapor penetration to the substrate.
